(19) United States
(12) Patent Application Publication
(10) Pub. No.: US 2020/0258364 A1
(43) Pub. Date: Aug. 13, 2020

(54) Human Activity Detection Using Thermal Data and Time-of-Flight Sensor Data

(71) Applicant: Osram GmbH, Munich (DE)

(72) Inventors: Michael A. Quilici, Essex, MA (US); Anant Aggarwal, Waltham, MA (US)

(21) Appl. No.: 16/269,715

(22) Filed: Feb. 7, 2019

(51) Int. Cl. G08B 21/04; G08B 21/18; H04N 5/33

(52) U.S. Cl. CPC G08B 21/043; G08B 21/0476; H04N 5/33; G08B 21/182; G08B 21/0492

(57) ABSTRACT

Methods, devices, and systems for detecting human activity using thermal data and time-of-flight (TOF) sensor data are disclosed. In some embodiments, an array-type thermal sensor is used to generate the thermal data and an array-type TOF sensor is used to generate the TOF data. TOF-derived data, such as distance data, velocity data, and/or acceleration data, can be determined from the TOF data. Human activity in a monitored space may be determined by comparing thermal and TOF-derived data acquired for the monitored space to one or more activity profiles corresponding to one or more types of activities desired to be monitored. Monitoring for human activity can be used for any one or more of a wide variety of purposes, such as controlling one or more environmental parameters and generating an alert that one or more activities, e.g., a fall event, has occurred, among many others.

### FIELD OF THE DISCLOSURE

The present disclosure generally relates to the field of human presence sensing. In particular, the present disclosure is directed to human activity detection using thermal data and time-of-flight sensor data.

### BACKGROUND

Falls not only cause injuries, but also lead to increased healthcare costs and even premature deaths. For example, between 700,000 and 1 million patients fall in U.S. hospitals every year, with 30%-35% resulting in injury and approximately 11,000 being fatal. Injuries related to falls can result in an additional 6.3 hospital days per patient. The average cost for a fall with injury is about $14,000 per patient. One hospital found most falls occurred when patients left their bed without assistance. Maintaining privacy is an important aspect of systems that track and monitor people. Conventional camera-based systems are often met with disapproval because of a perceived invasion of privacy, because subjects do not know what is being recorded or who may see the images, even when such a system simply provides no more than an alert that someone has fallen.

### SUMMARY OF THE DISCLOSURE

In one implementation, the present disclosure is directed to a method of detecting occurrence of activity of at least one person in a monitored space and generating an activity signal corresponding to the occurrence. The method includes monitoring the monitored region using an array-type thermal sensor to generate thermal data, monitoring the monitored region using an array-type time-of-flight (TOF) sensor to generate TOF data, calculating TOF-derived data from the TOF data, in which the TOF-derived data includes one or more of distance data, velocity data, and acceleration data, detecting occurrence of activity of the at least one person in the monitored space based on the thermal data and the TOF-derived data, and generating the activity signal in response to detecting occurrence of the activity of the at least one person in the monitored space.

In some implementations, detecting occurrence of the activity of the at least one person includes determining whether the TOF-derived data correlates to an activity profile characterizing the activity, detecting occurrence of the activity of the at least one person when the TOF-derived data correlates to the activity profile. In some implementations, the activity includes a fall event and the activity profile includes an acceleration profile characterizing the fall event. In some implementations, the activity profile includes at least one of an acceleration profile, a velocity profile, and a space-time coordinate profile. In some implementations, detecting occurrence of the activity of the at least one person includes analyzing the thermal data to determine a spatial location of the at least one person, analyzing the TOF-derived data to determine a spatial location of the activity, and detecting occurrence of the activity of the at least one person when the spatial location of the at least one person coincides with the spatial location of the activity. In some implementations, detecting occurrence of the activity of the at least one person includes analyzing the thermal data to determine a temporal location of the at least one person, analyzing the TOF-derived data to determine a temporal location of the activity, and detecting occurrence of the activity of the at least one person when the temporal location of the at least one person coincides with the temporal location of the activity. In some implementations, the array-type TOF sensor is mounted above the monitored region. In some implementations, the array-type thermal sensor includes a thermal imager having a resolution of 320×240 pixels or lower. In some implementations, the array-type TOF sensor includes a Lidar sensor having a resolution of 320×240 pixels or lower.

Further implementations disclosed herein include a system for detecting occurrence of activity of at least one person in a monitored space. The system includes an array-type thermal sensor for thermally monitoring the monitored region, the array-type thermal monitor generating thermal data, an array-type time-of-flight (TOF) sensor for monitoring the monitored region, the array-type TOF sensor generating TOF data, and a processor coupled to the array-type thermal sensor and the array-type TOF sensor, and configured to analyze the thermal data to determine presence of the least one person within the monitored region, calculate TOF-derived data from the TOF data, the TOF-derived data including at least one of distance data, velocity data, and acceleration data, detect occurrence of activity of the at least one person in the monitored space based on the thermal data and the TOF-derived data, and generate an activity signal in response to detecting occurrence of the activity of the at least one person in the monitored space.

In some implementations, the processor is configured to detect occurrence of the activity of the at least one person by determining whether the TOF-derived data correlates to an activity profile characterizing the activity, and detecting occurrence of the activity of the at least one person when the TOF-derived data correlates to the activity profile. In some implementations, the activity includes a fall event and the activity profile includes an acceleration profile characterizing the fall event. In some implementations, the activity profile includes at least one of an acceleration profile, a velocity profile, and a space-time coordinate profile. In some implementations, the processor is configured to detect occurrence of the activity of the at least one person by analyzing the thermal data to determine a spatial location of the at least one person, analyzing the TOF-derived data to determine a spatial location of the activity, and detecting occurrence of the activity of the at least one person when the spatial location of the at least one person coincides with the spatial location of the activity. In some implementations, the processor is configured to detect occurrence of the activity of the at least one person by analyzing the thermal data to determine a temporal location of the at least one person, analyzing the TOF-derived data to determine a temporal location of the activity, detecting occurrence of the activity of the at least one person when the temporal location of the at least one person coincides with the temporal location of the activity. In some implementations, the array-type TOF sensor is mounted above the monitored region. In some implementations, the array-type thermal sensor includes a thermal imager having a resolution of 320×240 pixels or lower. In some implementations, the array-type TOF sensor includes a Lidar sensor having a resolution of 320×240 pixels or lower.

Further implementations disclosed herein include a non-transitory computer-readable medium having stored thereon a computer program for detecting occurrence of activity of at least one person in a monitored space, the computer program including instructions to cause a computing device to perform a process including receiving thermal data generated by an array-type thermal sensor monitoring the monitored space, receiving time-of-flight (TOF) data generated by an array-type TOF sensor monitoring the monitored space, calculating TOF-derived data from the TOF data, in which the TOF-derived data includes one or more of distance data, velocity data, and acceleration data, detecting occurrence of activity of the at least one person in the monitored space based on the thermal data and the TOF-derived data, and generating the activity signal in response to detecting occurrence of the activity of the at least one person in the monitored space.

In some implementations, detecting occurrence of the activity of the at least one person includes determining whether the TOF-derived data correlates to an activity profile characterizing the activity, and detecting occurrence of the activity of the at least one person when the TOF-derived data correlates to the activity profile. In some implementations, the activity includes a fall event and the activity profile includes an acceleration profile characterizing the fall event. In some implementations, detecting occurrence of the activity of the at least one person includes analyzing the thermal data to determine a spatial location of the at least one person, analyzing the TOF-derived data to determine a spatial location of the activity, and detecting occurrence of the activity of the at least one person when the spatial location of the at least one person coincides with the spatial location of the activity. In some implementations, detecting occurrence of the activity of the at least one person includes analyzing the thermal data to determine a temporal location of the at least one person, analyzing the TOF-derived data to determine a temporal location of the activity, and detecting occurrence of the activity of the at least one person when the temporal location of the at least one person coincides with the temporal location of the activity.

### BRIEF DESCRIPTION OF THE DRAWINGS

For the purpose of illustrating the disclosure, the drawings show aspects of one or more embodiments of the disclosure. However, it should be understood that the present disclosure is not limited to the precise arrangements and instrumentalities shown in the drawings, wherein:

FIG. 1 is a graph of acceleration for a particular type of human fall event.

FIG. 2 is a diagram of an activity detection system made in accordance with aspects of the present disclosure.

FIG. 3 is a flow chart for a method of detecting occurrence of activity of at least one person within a monitored space and generating an activity signal in response to same in accordance with aspects of the present disclosure.

FIG. 4 is a flow chart for a method of determining a person within a monitored space has experienced a fall event and issuing an alert in response to same in accordance with aspects of the present disclosure.

FIG. 5 is schematic diagram of a computing device that can be used to implement any one or more of the aspects and/or functionalities described herein.

### DETAILED DESCRIPTION

In some aspects, the present disclosure is directed to method, systems, devices, and software for detecting occurrence of activities of one or more people within a monitored space using thermal and time-of-flight (TOF) sensors. Such methods, systems, devices, and/or software of the present disclosure can be used for a variety of applications, including but not limited to, detecting presence of one or more people for controlling lighting and/or other environmental aspect(s) (e.g., temperature and humidity) within the monitored space, determining the number of people within the monitored space, and detecting occurrences of human fall events, among many other applications.

Using fall events as an example of an “activity” in a general sense and as described in the background section above, falls can cause not only injury to the fallen person, but also increases in healthcare costs and even deaths. However, people can be leery of fall-detection systems, and human-presence detection systems more generally, that utilize high-resolution imaging as they consider them to invade on their privacy. Therefore, a solution that allows for human presence and fall detection systems that provide high accuracy but do not require high-resolution imaging is desirable.

One solution to providing such presence and fall detection systems (both species of an “activity-detection system”) is to use both thermal sensing and TOF sensing. An advantage of using both thermal and TOF sensing is the ability to detect one or more hot spots (e.g., people), which can simply appear as nondescript “thermal blobs” (i.e., shapes lacking personally identifiable information) if or when viewed in thermal images, determine the corresponding location(s) of the thermal blob(s)/corresponding person/people, and compute distance(s) (e.g., from a TOF sensor, floor, or other reference), velocity(ies), and/or acceleration(s) associated with the thermal blob(s)/person/people, all with little or no personally identifiable information present in any of the data used.

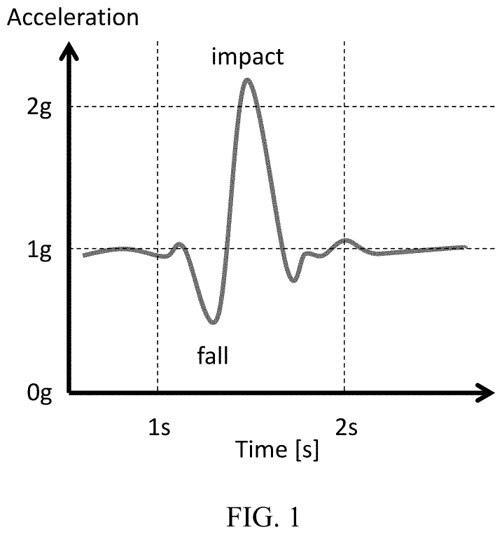

For example, a thermal sensor may detect warm pixels that correspond to the presence of a person, while a TOF sensor provides measurements that allow calculation of accelerations experienced by that person. In a fall-event embodiment, and as illustrated in FIG. 1, there may be an initial drop in acceleration during the free-fall phase, followed by a rapid positive acceleration associated with an impact. Fall events come in a wide variety of forms and can have more complex acceleration curves, or “activity profiles,” and varying levels of severity, so an activity-detection system made in accordance with aspects of this disclosure utilize one or more appropriate software algorithms to interpret the data in order, for example, to assign a likelihood that a fall and/or other detectable activity has occurred prior to the activity-detection system generating an activity signal and optionally generating and sending a notification signal. As another scenario, there may also be situations in which acceleration and/or velocity information has not indicated that a person has fallen, but the person is stationary on the floor. In this scenario, if the activity-detection system detects that a person is on or near the floor for at least a predetermined period of time, the activity-detection system may generate and issue a notification signal. Here, the distance information that the TOF sensor provides is beneficial for this scenario, because thermal data alone would not indicate how close the person is to the floor. Other scenarios are noted below, and others will become apparent to those skilled in the art after reading and understanding this entire disclosure. Those skilled in the art will understand how to collect and assess data, including TOF data, for classifying differing types of falls based on their TOF data profiles.

More broadly, TOF data can be used in conjunction with thermal data to determine the mere presence of one or more people within the monitored space or activity(ies) other than fall events. However, instead of acceleration profiles corresponding to various types of fall events, acceleration, velocity, and/or distance profile(s) corresponding to the type(s) of movement events desired to be detected can be used. Such TOF-data-derived profiles can be fused with corresponding thermal profiles. As a simple example, a person-counting application may use TOF-data-derived profiles indicating horizontal movement (horizontal in a world-frame sense) along with individual thermal blob detection to determine the likelihood that a certain number of people are present within the monitored space. Those skilled in the art will be able to structure the TOF-data-derived profiles and thermal-blob-detection algorithms to conform to the application under consideration.

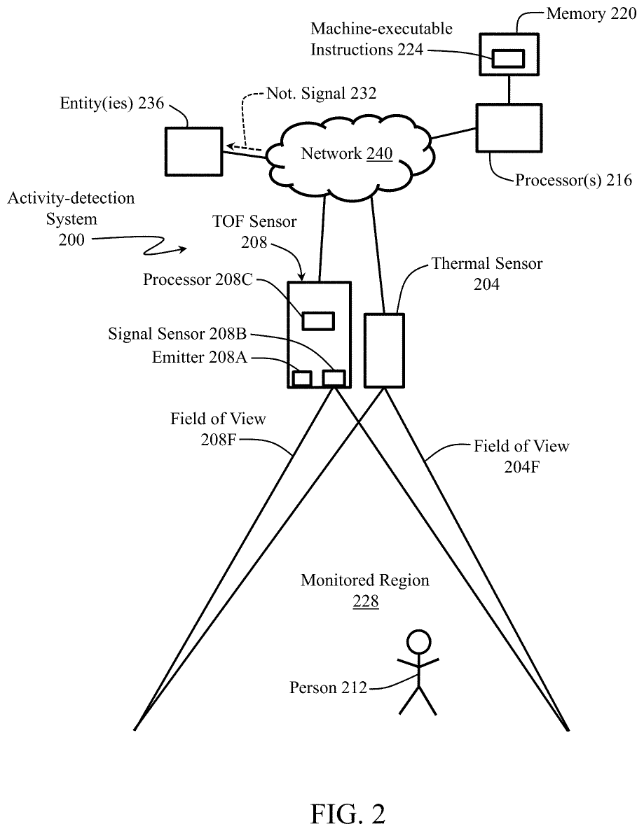

Turning now to the accompanying drawings, FIG. 2 illustrates an activity-detection system 200 made in accordance with aspects of the present disclosure. In this embodiment and for the sake of illustration only, activity-detection system 200 is specifically implemented as a fall-detection system, and, consequently, the various features of the activity-detection system are described accordingly. However, it is emphasized that the specific features of activity-detection system 200 applicable to fall detection can be generalized and/or modified to adapt the activity-detection system to an application other than fall detection.

As seen in FIG. 2, activity-detection system 200 includes a thermal sensor 204 and a TOF sensor 208. Thermal sensor 204 may be any thermal sensor capable of detecting heat from a human body, such as a pyroelectric infrared sensor, thermopile sensor, or a thermal imager, among others, or any combination thereof. In some embodiments, a multipixel thermal sensor is desirable to provide thermal data that helps better characterize the nature of the content of the thermal images that the thermal sensor typically generates. However, for many applications it is desirable to strike a balance between the ability to characterize the nature of the thermal image content with the privacy of people being monitored by activity-detection system 200. The latter counsels that the resolution of thermal sensor 204 should be relatively low to avoid images acquired therefrom from containing personally identifiable information. For such privacy concerns, it is generally desirable that the resolution of thermal sensor 204 be 640×480 pixels or lower, 320×240 pixels or lower, 80×80 pixels or lower, or 32×24 pixels or lower, to identify a few low-resolution ranges. However, selection of the resolution of thermal sensor 204 needs to consider variables such as the distance of the thermal sensor from the objects being monitored and the focal length of any lens system (not shown) used with the thermal sensor, among other things. Generally, a multi-pixel thermal sensor having a resolution of at least 2×2 pixels is desirable.

As those skilled in the art understand, TOF sensor 208 is a sensor having an emitter 208A that emits a signal and a signal sensor 208B that senses the signal, or an altered form thereof, that returns from an object, here a person 212, spaced from the TOF sensor 208. TOF sensor 208 also includes an onboard processor 208C that controls the operation of the TOF sensor 208 and calculates the TOF of the emitted signal, i.e., the time between the time emitter 208A emitted the signal and the time signal sensor 208B received the signal. As those skilled in the art will readily understand, the TOF data collected by TOF sensor 208 can be used to calculate distance(s) between the TOF sensor 208 and object 212, velocity(ies) of the object, and/or acceleration(s) of the object. For the sake of convenience, this distance, velocity, and/or acceleration data is referred to herein and in the appended claims as TOF-derived data, since it is derived from the raw TOF data acquired using signal sensor 208B.

TOF sensor 208 may be any suitable TOF sensor capable of providing TOF data from which useful information, such as acceleration data, velocity data, and/or distance data, can be determined. Examples of TOF sensors that can be used for TOF sensor 208 include, but are not limited to optical TOF sensors (e.g., laser-based TOF cameras and light detection and ranging (Lidar) sensors), radio-frequency TOF sensors (e.g., RADAR), and sonic TOF sensors (e.g., acoustic ranging systems), among others. Fundamentally, there are no limitations on the types of thermal and TOF sensors 204, 208 other than that they provide the data for detection and that they do not harm or otherwise interfere with any people or objects within range of the sensors. However, since many applications for activity-detection system 200 have privacy concerns, in a manner similar to thermal sensor 204, a multi-pixel version of TOF sensor 208 should have a suitable low resolution, such as 640×480 pixels or lower, 320×240 pixels or lower, 80×80 pixels or lower, or 32×24 pixels or lower, to identify a few low-resolution ranges. However, selection of the resolution of TOF sensor 208 needs to consider variables such as the distance of the TOF sensor from the objects being monitored and the focal length of the lens system used with the TOF sensor, among other things. Generally, a multi-pixel TOF sensor having a resolution of at least 2×2 pixels is desirable.

It is noted that in the foregoing description, a statement addressing a component of activity-detection system 200 in the singular shall mean that the activity-detection system can include one or more of the components. For example, one embodiment of activity-detection system 200 may include one thermal sensor 204, while another embodiment may include more than one thermal sensor 204. Likewise, while one embodiment of activity-detection system 200 may include a TOF sensor 208 having a single signal sensor 208B, another embodiment may include a TOF sensor 208 having more than one signal sensor 208B.

In the illustrated embodiment, activity-detection system 200 also includes one or more processors (collectively illustrated as processor(s) 216) and memory 220 that includes machine-executable instructions 224 for, among other things, performing any one or more of the activity-detection functionalities described herein, as well as for performing functions that support and/or enable the performing of such activity-detection functionalities. Processor(s) 216 may be located in any suitable location, including local to thermal and TOF sensors 204, 208 (e.g., in the same device) or remote from the thermal and TOF sensors, such as on a local-area network (LAN), wide-area network (WAN), or global network (e.g., the Internet), that includes the thermal and TOF sensors.

In this embodiment, each processor 216 may be, for example, any suitable type processor, such as a microprocessor, an application specific integrated circuit, part of a system on a chip, or a field-programmable gate array, among other architectures. Memory 220 may be or include any type(s) of suitable machine memory, such as cache, RAM, ROM, PROM, EPROM, and/or EEPROM, among others. Machine memory can also be or include another type of machine memory, such as a static or removable storage disk, static or removable solid-state memory, and/or any other type of persistent hardware-based memory. Fundamentally, there is no limitation on the type(s) of memory other than it be embodied in hardware.

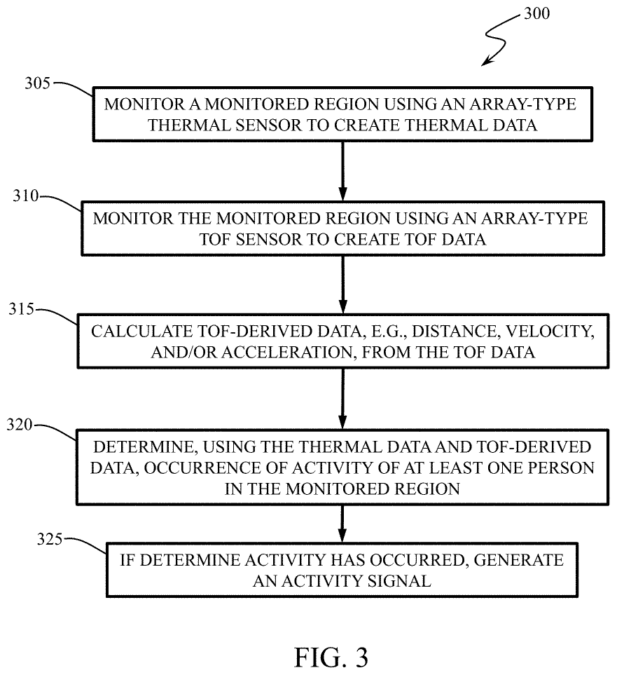

Machine-executable instructions 224 may be embodied in software, firmware, and/or any other suitable form. In some embodiments, machine-executable instructions 224 encode activity-detection algorithms that allow processor 216 to process thermal data and TOF data from, respectively, thermal sensor 204 and TOF sensor 208. For example, the activity-detection algorithms may determine distance, velocity, and/or acceleration, as well as determine whether one or more person has fallen or is likely to have fallen. As described below in more detail, including in conjunction with FIG. 3, the activity-detection algorithm may determine the likelihood that one or more people have fallen by comparing data obtained from and/or derived from thermal data and/or TOF data to one or more activity profile data sets stored in memory 220.

In the illustrated embodiment, thermal sensor 204 and TOF sensor 208 are co-located with one another and aimed so as to collect, respectively, thermal data and TOF data for any object, such as person 212, within overlapping or coincident respective fields of view 204F, 208F of the thermal and TOF sensors that together define a monitored region 228. As used herein the term “monitored region”, indicated generally at 228, denotes the region of space within the overlapping portions of the fields of view 204F, 208F in which one or more objects, such as persons, can be detected in accordance with techniques disclosed herein. The overlapping or coincidence of fields of view 204F, 208F allows activity-detection system 200 to determine when the presence of a monitored object (e.g., person 212) coincides with a TOF data profile, in space-time coordinates, such that the activity-detection system can infer that the TOF data profile corresponds to the person (e.g., it was a person that fell and not an inanimate object). As an example, the activity-detection algorithms can use the locations of the pixels within the corresponding sensor arrays of thermal and TOF sensors 204 and 208 in which, respectively, thermal activity and acceleration activity are being sensed to determine whether those activities occurred in a spatial (e.g., x-y) proximity relative to one another that would indicate a fall event. For example, if thermal sensor 204 has a 360×240 pixel array and sensed a thermal mass at the “upper right-hand” corner of the array and TOF sensor 208 has a 360×240 pixel array and simultaneously sensed acceleration activity at the “lower right-hand” corner of the array, then activity-detection system 200 may determine that the disparate locations of the activities indicate that a fall (as determined from the TOF data) of person 212 (as determined from the thermal data) has not occurred. In this embodiment, the activity sensed by TOF sensor 208 may, for example, have been caused by a falling inanimate object (not shown) located away from person 212.

In the illustrated embodiment, thermal and TOF sensors 204, 208 are located directly vertically above monitored region 228, for example, mounted to or in a ceiling (not shown) or other structure. However, in other embodiments, thermal and TOF sensors 204, 208 may be located other than directly vertically above detection region, such as being mounted to a wall or other vertical building component, among other things. In addition, in other embodiments thermal and TOF sensors 204, 208 need not be co-located with one another. Generally, a primary feature of locating thermal and TOF sensors 204, 208 relative to one another is that activity-detection system 200 can correlate thermal data and TOF data with one another by spatial location in assessing whether the TOF data corresponds to a person as determined by the thermal data. Locating at least TOF sensor 208 vertically above monitored region 228 can aid in discrimination of falling events, because the accelerations experienced by a human body during a fall are typically predominately vertical in nature due to gravitational pull of Earth.

Machine-executable instructions 224 may also include machine-executable instructions for generating one or more activity signals (not shown) that provide an indication that activity-detection system 200 has detected an activity it has been configured to detect. Optionally, machine-executable instructions 224 may also generate and transmit one or more notification signals 232, for example, based on activity signal, that provide notification that activity-detection system 200 has detected something it has been configured to detect. Each activity signal may be, for example, a flag, descriptor, or other entry into a data set, such as into a data field of a datastore, among other things. Fundamentally, there is no limitation on the nature of an activity signal.

In the context of a fall-detection embodiment of activity-detection system 200, the activity-detection system may generate and send the one or more notification signals 232 when it has determined that a person, here, person 212, is likely to have experienced a fall event of a nature that warrants an alert be issued, for example, to one or more entities 236 (e.g., an event tracking system, an alert system, etc.), which may in turn notify one or more people (e.g., a caretaker, nurse, relative, etc.) (not shown). An alert triggered by notification signal 232 may be of any suitable type, including, but not limited to, an alert light inside and/or outside of the monitored space, a mobile device alert (e.g., on a pager, smartphone, or other device), a care-taker station alert (e.g., a light and/or audible sound via a monitor board and/or a computing device), an ambulance-station alert, etc., and any combination thereof. In other applications, an entity 236 may be, for example, a control device for an environmental control, such as a smart lighting control, a smart thermostat, or a smart humidistat, among others. In some cases, activity-detection system 200 may send some or all of notification signals 232 over one or more networks, represented collectively as network 240. It is also noted that network 240 may handle communications between thermal and TOF sensors 204, 208 and processor 216 as shown. Alternatively, however, thermal and TOF sensors 204, 208 and processor 216 may be in communication via a hardwired connection, as may be each entity 236.

FIG. 3 illustrates a method 300 of determining occurrence of activity(ies) of at least one person that is/are desired to be detected, and providing a corresponding activity signal. In this embodiment and referring to FIG. 2 for an example context for method 300, at block 305 a monitored region, such as monitored region of FIG. 2, is monitored using an array-type thermal sensor so as to create thermal data. Depending on the application, the monitored region may be any suitable region, such as, for example, a region within a room (e.g., hospital room, hotel room, bedroom, bathroom, etc.) desired to be monitored for falls. When activity-detection system 200 is utilized in method 300, the thermal monitoring at block 305 is performed using thermal sensor 204. When thermal sensor 204 includes a thermal-imaging array-type sensor, the thermal data may be characterized as a time-series of thermal maps (data) of the field of view of the thermal sensor. The field of view of thermal sensor 204 may include or be coextensive with monitored region 228.

Similarly, at block 310, the monitored region, such as monitored region 228 of FIG. 2, is monitored using a TOF sensor to create TOF data. When activity-detection system 200 is utilized in method 300, TOF monitoring at block 310 is performed using TOF sensor 208. When TOF sensor 208 includes a TOF-imaging array-type sensor, the TOF data may be characterized as a time-series of depth, or distance, maps of the field of view of the TOF sensor. The field of view of TOF sensor 208 may include or be coextensive with the field of view of thermal sensor 204 and covers monitored region 228. At block 315, the data underlying the distance maps may be processed to calculate TOF-derived data, which may be, for example, one or more distance maps, one or more acceleration maps, and/or one or more velocity maps to determine how distances within the distance maps may be changing over time. It is noted that “maps” may be considered synonymous with “data.” For example, as discussed above relative to FIG. 1, differing fall events (activities) can have differing acceleration and/or velocity profiles. When performed by activity-detection system 200 of FIG. 2, the calculations at block 315 are made by processor 208C if done onboard TOF sensor 208 and/or by processor 216 executing suitable algorithms encoded in machine-executable instructions 224.

At block 320, the thermal data and the TOF-derived data are used to determine whether a person is within the monitored region and/or whether the person has participated in an activity. For the sake of this disclosure and the appended claims, an “activity” does not require movement (e.g., a person is engaged in an activity if they are sitting still or lying still) and does not require an affirmative choice to participate in the activity (e.g., a person does not choose to have an accidental fall or be lying on the floor unconscious). When this determination is made using activity-detection system 200 of FIG. 2, it is performed by processor 216 executing suitable activity-detection algorithms encoded in machine-executable instructions 224. In some embodiments, thermal data and TOF-derived data may be fused together to create an acquired-data set that may then be compared to one or more stored activity profiles to determine one or more confidence scores, or similar scores, that indicate the quality of the match(es) between the acquired-data set and the one or more activity profiles. Such matching and scoring may be performed by any suitable algorithms, such as a convolutional neural network (CNN) algorithm or other data or image matching algorithm, which may be embodied in machine-executable instructions 224. In some embodiments, thermal data and acceleration data may be augmented with depth and/or velocity data to characterize certain events. For example, if the thermal data indicates that a person is present, but the acceleration data is inconclusive relative to identifying that a fall has occurred, a series of distance maps that reveal that the person has been near the floor for an extended period of time can be used in helping to determine that a fall—one that has resulted in the person laying on the floor for a concerning amount of time—has occurred.

It is noted that the thermal data and the TOF-derived data need not be fused and analyzed as a composite of data. For example, one or the other of the thermal data and acceleration data may be continuously monitored for a meaningful change. Then, when it is determined that a meaningful change or event has occurred, the other of the thermal data and acceleration data can be monitored for a corresponding occurrence of a fall event or coincidence of activity. For example, in one scenario the thermal data may be initially monitored for a change in x-y location of a person. Perhaps the person has been lying in bed for hours but has now started moving to one side of the bed to exit. Activity-detection system 200 may recognize this movement and then in real-time, start analyzing acceleration data derived from the TOF data to determine whether the person experiences a fall from the bed or while getting out of bed. In another scenario, the acceleration data may be continually monitored and assessed to determine whether an acceleration-determined fall event has occurred. If so, activity-detection system 200 may then analyze the thermal data to determine whether the thermal blob representing the person in the thermal map is spatially coincident with the fall event to distinguish a falling person from a falling inanimate object. As another example, activity-detection system 200 may continuously monitor both thermal data and acceleration (and/or velocity and distance data) to determine spatial and temporal coincidence of the person with the occurrence of TOF-data-derived indicia of a movement event. Other movement-event and/or presence detection schemes and corresponding algorithms are possible.

At block 325, in response to having determined that a detectable movement-event is likely to have occurred, an activity signal is generated. Optionally, a notification signal may be generated and sent to one or more appropriate recipients. When activity-detection system 200 of FIG. 2 is used to implement method 300, the generation of each of the activity signal and notification signal 232 may be performed by processor 216 executing suitable algorithms encoded in machine-executable instructions 224. Depending on the application of method 300 and the people (e.g., people 212 of FIG. 2) and/or entities (e.g., entities 236 of FIG. 2) that need to receive the notification signal, the notification signal may be of any suitable type and composition. As noted above, the activity signal may also be of any suitable type and composition.

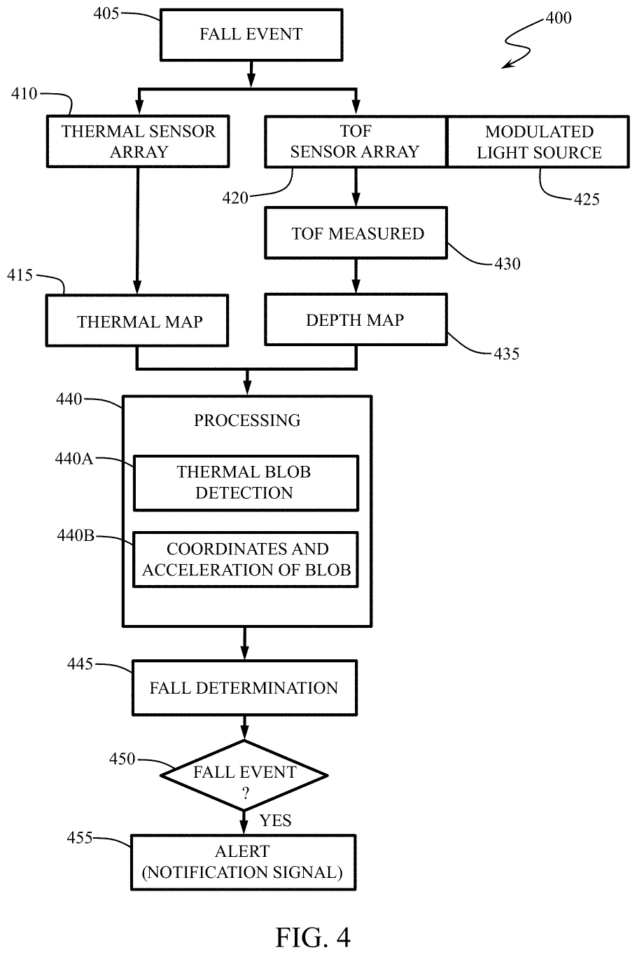

FIG. 4 illustrates a method 400 of issuing a notification signal in response to a fall event, which includes a slip, trip, or other fall event. At block 405, the fall event occurs. At block 410, a thermal sensor array is provided. In the context of activity-detection system 200 of FIG. 2, the thermal sensor array may be part of thermal sensor 204. At block 415, a time-series of thermal maps are created using thermal data from the thermal sensor array. At least some of the thermal maps include a thermal image of a person (e.g., person 212 of FIG. 2) experiencing the fall. At blocks 420 and 425, a TOF sensor array and a modulated light source, respectively, are provided. In the context of activity-detection system 200 of FIG. 2, both the TOF sensor array and the modulated light source may be part of TOF sensor 208 and may be controlled by onboard processor 208C. At block 430, TOF is measured, either directly using individual pulses or indirectly, via phase shift detection, using a modulated waveform, such as a series of square waves, sine waves, sawtooth wave, etc. At block 435, a time-series of depth maps are created using the TOF data measured at block 430. In the context of activity-detection system 200 of FIG. 2, the TOF measurements and depth map creation of, respectively, blocks 430 and 435 may be performed using onboard processor 208C.

At block 440, the thermal maps and depth maps (and/or data underlying both types of maps) are processed using suitable algorithms, such as algorithms encoded in machine-executable instructions 224 of FIG. 2. Examples of processing that can occur at block 440 include detecting the thermal blob in the thermal maps (block 440A) and determining 1) coordinates for the thermal blob using the thermal maps (block 440B), and 2) accelerations of the thermal blob using the depth maps (block 440B).

After determining the accelerations of the thermal blob, at block 445, it is determined whether the person, represented by the thermal blob, has experienced a fall event, as evidenced by the acceleration profile determined using the depth maps. As an example, the acceleration profile of the thermal blob over a particular span of time can be compared to one or more stored activity profiles characterizing typical fall events to determine one or more confidence scores that represents the confidence that the actual acceleration profile matches the one or more stored activity profiles. Determination that the person has fallen may be made by comparing each of the one or more confidence scores to a predetermined threshold value. At decision block 450, if it is determined that any confidence score is equal to or greater than the predetermined threshold, then method may proceed to block 455 at which an alert is provided. Such an alert may include, for example, a notification signal that triggers a device to issue an alert, such as an electronic notification, audio alert, visual alert, or any combination thereof. If at decision block 450 all of the one or more confidence scores are less than the predetermined threshold values, then no notification signal is generated. If performed using activity-detection system 200 of FIG. 2, the functions of blocks 445, 450, and 455 may be accomplished using algorithms encoded in machine-executable instructions 224.

Any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

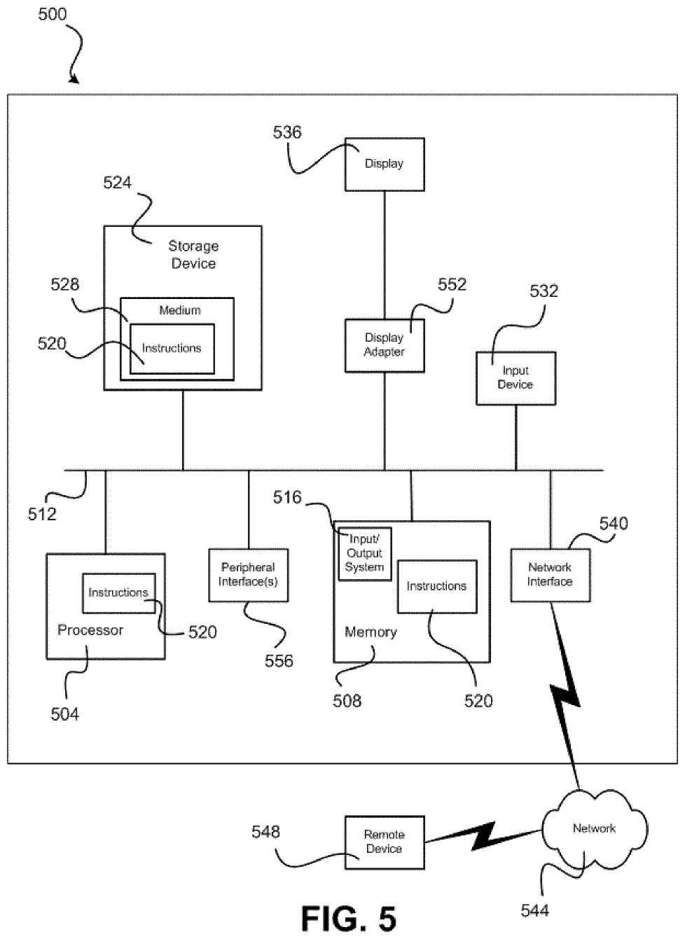

FIG. 5 shows a diagrammatic representation of one embodiment of a computing device in the example form of a computer system 500 within which a set of instructions for causing a central PCD to perform any one or more of the aspects and/or methodologies of the present disclosure may be executed. It is also contemplated that each of multiple personal mobile computing devices may be utilized to implement a specially configured set of instructions for causing one or more of the central PCDs to perform any one or more of the aspects and/or methodologies of the present disclosure. Computer system 500 includes a processor 504 and a memory 508 that communicate with each other, and with other components, via a bus 512. Bus 512 may include any of several types of bus structures including, but not limited to, a memory bus, a memory controller, a peripheral bus, a local bus, and any combinations thereof, using any of a variety of bus architectures.

Memory 508 may include various components (e.g., machine-readable media) including, but not limited to, a random access memory component, a read only component, and any combinations thereof. In one example, a basic input/output system 516 (BIOS), including basic routines that help to transfer information between elements within computer system 500, such as during start-up, may be stored in memory 508. Memory 508 may also include (e.g., stored on one or more machine-readable media) instructions (e.g., software) 520 embodying any one or more of the aspects and/or methodologies of the present disclosure. In another example, memory 508 may further include any number of program modules including, but not limited to, an operating system, one or more application programs, other program modules, program data, and any combinations thereof.

Computer system 500 may also include a storage device 524. Examples of a storage device (e.g., storage device 524) include, but are not limited to, a hard disk drive, a magnetic disk drive, an optical disc drive in combination with an optical medium, a solid-state memory device, and any combinations thereof. Storage device 524 may be connected to bus 512 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 524 (or one or more components thereof) may be removably interfaced with computer system 500 (e.g., via an external port connector (not shown)). Particularly, storage device 524 and an associated machine-readable medium 528 may provide nonvolatile and/or volatile storage of machine-readable instructions, data structures, program modules, and/or other data for computer system 500. In one example, software 520 may reside, completely or partially, within machine-readable medium 528. In another example, software 520 may reside, completely or partially, within processor 504.

Computer system 500 may also include an input device 532. In one example, a user of computer system 500 may enter commands and/or other information into computer system 500 via input device 532. Examples of an input device 532 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 532 may be interfaced to bus 512 via any of a variety of interfaces (not shown) including, but not limited to, a serial interface, a parallel interface, a game port, a USB interface, a FIREWIRE interface, a direct interface to bus 512, and any combinations thereof. Input device 532 may include a touch screen interface that may be a part of or separate from display 536, discussed further below. Input device 532 may be utilized as a user selection device for selecting one or more graphical representations in a graphical interface as described above.

A user may also input commands and/or other information to computer system 500 via storage device 524 (e.g., a removable disk drive, a flash drive, etc.) and/or network interface device 540. A network interface device, such as network interface device 540, may be utilized for connecting computer system 500 to one or more of a variety of networks, such as network 544, and one or more remote devices 548 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 544, may employ a wired and/or a wireless mode of communication. In general, any network topology may be used. Information (e.g., data, software 520, etc.) may be communicated to and/or from computer system 500 via network interface device 540.

Computer system 500 may further include a video display adapter 552 for communicating a displayable image to a display device, such as display device 536. Examples of a display device include, but are not limited to, a liquid crystal display (LCD), a cathode ray tube (CRT), a plasma display, a light emitting diode (LED) display, and any combinations thereof. Display adapter 552 and display device 536 may be utilized in combination with processor 504 to provide graphical representations of aspects of the present disclosure. In addition to a display device, computer system 500 may include one or more other peripheral output devices including, but not limited to, an audio speaker, a printer, and any combinations thereof. Such peripheral output devices may be connected to bus 512 via a peripheral interface 556. Examples of a peripheral interface include, but are not limited to, a serial port, a USB connection, a FIREWIRE connection, a parallel connection, and any combinations thereof.

The foregoing has been a detailed description of illustrative embodiments of the disclosure. It is noted that in the present specification and claims appended hereto, conjunctive language such as is used in the phrases “at least one of X, Y and Z” and “one or more of X, Y, and Z,” unless specifically stated or indicated otherwise, shall be taken to mean that each item in the conjunctive list can be present in any number exclusive of every other item in the list or in any number in combination with any or all other item(s) in the conjunctive list, each of which may also be present in any number. Applying this general rule, the conjunctive phrases in the foregoing examples in which the conjunctive list consists of X, Y, and Z shall each encompass: one or more of X; one or more of Y; one or more of Z; one or more of X and one or more of Y; one or more of Y and one or more of Z; one or more of X and one or more of Z; and one or more of X, one or more of Y and one or more of Z.

Various modifications and additions can be made without departing from the spirit and scope of this disclosure. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present disclosure. Additionally, although particular methods herein may be illustrated and/or described as being performed in a specific order, the ordering is highly variable within ordinary skill to achieve aspects of the present disclosure. Accordingly, this description is meant to be taken only by way of example, and not to otherwise limit the scope of this disclosure.

Exemplary embodiments have been disclosed above and illustrated in the accompanying drawings. It will be understood by those skilled in the art that various changes, omissions and additions may be made to that which is specifically disclosed herein without departing from the spirit and scope of the present disclosure.

1. A method of detecting occurrence of activity of at least one person in a monitored region and generating an activity signal corresponding to the occurrence, the method comprising:
monitoring the monitored region using an array-type thermal sensor to generate thermal data;
monitoring the monitored region using an array-type time-of-flight (TOF) sensor to generate TOF data;
calculating TOF-derived data from the TOF data, wherein the TOF-derived data includes one or more of distance data, velocity data, and acceleration data;
detecting occurrence of activity of the at least one person in the monitored space based on the thermal data and the TOF-derived data by:
determining whether the TOF-derived data correlates to an activity profile characterizing the activity, wherein the activity comprises a fall event and the activity profile includes an acceleration profile specifying acceleration over time of the fall event; and
detecting occurrence of the activity of the at least one person when the TOF-derived data correlates to the activity profile; and
generating the activity signal in response to detecting occurrence of the activity of the at least one person in the monitored space.

2-3. (canceled)

4. The method of claim 1, wherein the activity profile further includes at least one of a velocity profile, and a space-time coordinate profile.

5. The method of claim 1, wherein detecting occurrence of the activity of the at least one person further comprises:
analyzing the thermal data to determine a spatial location of the at least one person;
analyzing the TOF-derived data to determine a spatial location of the activity; and
detecting occurrence of the activity of the at least one person when the spatial location of the at least one person coincides with the spatial location of the activity.

6. The method of claim 1, wherein detecting occurrence of the activity of the at least one person further comprises:
analyzing the thermal data to determine a temporal location of the at least one person;
analyzing the TOF-derived data to determine a temporal location of the activity; and
detecting occurrence of the activity of the at least one person when the temporal location of the at least one person coincides with the temporal location of the activity.

7. The method of claim 1, wherein the array-type TOF sensor is mounted above the monitored region.

8. The method of claim 1, wherein the array-type thermal sensor comprises a thermal imager having a resolution of 320×240 pixels or lower.

9. The method of claim 1, wherein the array-type TOF sensor comprises a Lidar sensor having a resolution of 320×240 pixels or lower.

10. A system for detecting occurrence of activity of at least one person in a monitored region, the system comprising:
an array-type thermal sensor for thermally monitoring the monitored region, the array-type thermal monitor generating thermal data;
an array-type time-of-flight (TOF) sensor for monitoring the monitored region, the array-type TOF sensor generating TOF data;
a processor coupled to the array-type thermal sensor and the array-type TOF sensor, and configured to:
analyze the thermal data to determine presence of the least one person within the monitored region;
calculate TOF-derived data from the TOF data, the TOF-derived data comprising at least one of distance data, velocity data, and acceleration data;
detect occurrence of activity of the at least one person in the monitored space based on the thermal data and the TOF-derived data by:
determining whether the TOF-derived data correlates to an activity profile characterizing the activity, wherein the activity comprises a fall event and the activity profile includes an acceleration profile specifying acceleration over time of the fall event; and
detecting occurrence of the activity of the at least one person when the TOF-derived data correlates to the activity profile; and
generate an activity signal in response to detecting occurrence of the activity of the at least one person in the monitored space.

11-12. (canceled)

13. The system of claim 10, wherein the activity profile further includes at least one of a velocity profile, and a space-time coordinate profile.

14. The system of claim 10, wherein the processor is further configured to detect occurrence of the activity of the at least one person by:
analyzing the thermal data to determine a spatial location of the at least one person;
analyzing the TOF-derived data to determine a spatial location of the activity; and
detecting occurrence of the activity of the at least one person when the spatial location of the at least one person coincides with the spatial location of the activity.

15. The system of claim 10, wherein the processor is further configured to detect occurrence of the activity of the at least one person by:
analyzing the thermal data to determine a temporal location of the at least one person;
analyzing the TOF-derived data to determine a temporal location of the activity; and
detecting occurrence of the activity of the at least one person when the temporal location of the at least one person coincides with the temporal location of the activity.

16. The system of claim 10, wherein the array-type TOF sensor is mounted above the monitored region.

17. The system of claim 10, wherein the array-type thermal sensor comprises a thermal imager having a resolution of 320×240 pixels or lower.

18. The system of claim 10, wherein the array-type TOF sensor comprises a Lidar sensor having a resolution of 320×240 pixels or lower.

19. A non-transitory computer-readable medium having stored thereon a computer program for detecting occurrence of activity of at least one person in a monitored space, the computer program comprising instructions to cause a computing device to perform a process comprising:
receiving thermal data generated by an array-type thermal sensor monitoring the monitored space;
receiving time-of-flight (TOF) data generated by an array-type TOF sensor monitoring the monitored space;
calculating TOF-derived data from the TOF data, wherein the TOF-derived data includes one or more of distance data, velocity data, and acceleration data;
detecting occurrence of activity of the at least one person in the monitored space based on the thermal data and the TOF-derived data by:
determining whether the TOF-derived data correlates to an activity profile characterizing the activity, wherein the activity comprises a fall event and the activity profile includes an acceleration profile specifying acceleration over time of the fall event; and
detecting occurrence of the activity of the at least one person when the TOF-derived data correlates to the activity profile; and
generating the activity signal in response to detecting occurrence of the activity of the at least one person in the monitored space.

20-21. (canceled)

22. The non-transitory computer-readable medium of claim 19, wherein detecting occurrence of the activity of the at least one person further comprises:
analyzing the thermal data to determine a spatial location of the at least one person;
analyzing the TOF-derived data to determine a spatial location of the activity; and
detecting occurrence of the activity of the at least one person when the spatial location of the at least one person coincides with the spatial location of the activity.

23. The non-transitory computer-readable medium of claim 19, wherein detecting occurrence of the activity of the at least one person further comprises:
analyzing the thermal data to determine a temporal location of the at least one person;
analyzing the TOF-derived data to determine a temporal location of the activity; and
detecting occurrence of the activity of the at least one person when the temporal location of the at least one person coincides with the temporal location of the activity.
